(19) United States
(12) Patent Application Publication
(10) Pub. No.: US 2021/0017364 A1
(43) Pub. Date: Jan. 21, 2021

(54) Ultra-Soft Impact Copolymer Polypropylene with Nanostructured Morphology

(71) Applicant: ExxonMobil Chemical Patents Inc., Baytown, TX (US)

(72) Inventors: Carlos R. Lopez-Barron, Houston, TX (US); Hamidreza Khakdaman, Houston, TX (US); Brian J. Rohde, Houston, TX (US); Sung A. Kim, Houston, TX (US)

(21) Appl. No.: 16/928,806

(22) Filed: Jul. 14, 2020

Related U.S. Application Data
(60) Provisional application No. 62/876,393, filed on Jul. 19, 2019.

(51) Int. Cl. C08L 23/12; C08L 23/20

(52) U.S. Cl. CPC C08L 23/12; C08L 23/20

(57) ABSTRACT

An impact copolymer composition comprising a continuous phase comprising polypropylene and from 10 wt % to 80 wt % of a dispersed phase, based on the total amount of the composition, comprising a copolymer of ethylene and a C₄-C₈ alpha-olefin, the dispersed phase having an average particle size of less than 500 nm. A process for making is also disclosed.

### CROSS-REFERENCE TO RELATED APPLICATIONS

This application claims priority to U.S. Ser. No. 62/876,393, filed Jul. 19, 2019, herein incorporated by reference.

This application is related to U.S. Ser. No. 62/876,421, (2019EM248) filed Jul. 19, 2019, herein incorporated by reference.

### BACKGROUND

Impact copolymers (ICP) are characterized as having an elastomeric phase dispersed in a polyolefin. Impact copolymers have a myriad of uses. In applications such as in roofing, it is desirable to have impact copolymer formulations with a relatively low elastic modulus, which often requires incorporating relatively large amounts of various forms of ethylene-propylene (EP) rubber into the formulation. The lower limit of elastic modulus is ultimately determined by the modulus of the rubber. Additionally, in impact copolymers the average particle size of the dispersed rubber particles, also referred to as domain size, and the uniformity of the dispersion is often associated with the toughness of the material. Typically, ethylene-propylene copolymers are used as the rubber phase in impact copolymers. These copolymers are highly immiscible with many polyolefins, rendering the average particle size of the rubber domains less than optimal.

There is a need in the art for impact copolymer and other formulations having low elastic modulus and a highly dispersed discontinuous phase.

### SUMMARY

In embodiments, an impact copolymer composition comprises a polypropylene continuous phase and a dispersed phase comprising an ethylene-C₄-C₈ olefin rubber, where the dispersed phase has an average domain size of less than 500 nm, preferably less than 100 nm, preferably less than or equal to about 50 nm. In embodiments, the rubber dispersed phase is fully miscible with the polypropylene continuous phase under melt conditions.

In one or more embodiments of the invention, an impact copolymer composition comprises a continuous phase comprising propylene and from 10 wt % to 80 wt % of a dispersed phase, based on the total amount of the composition, comprising a copolymer of ethylene and a C₄-C₈ alpha-olefin having an average particle size of less than 500 nm.

In one or more embodiments of the invention, a process to produce an impact copolymer composition comprises the steps of combining a first component comprising propylene with from 10 wt % to 80 wt % of a second component, based on the total weight of the first and second components, comprising a copolymer of ethylene and a C₄-C₈ alpha-olefin under melt conditions to form a homogenous melt mixture in which the first component and the second component are fully melt miscible; cooling the melt mixture to form the impact copolymer composition comprising the first component as a continuous phase and the second component as a dispersed phase having an average particle size of less than 500 nm.

In one or more embodiments of the invention, an article or manufacture comprises one or more embodiments of the impact copolymer composition according to the instant disclosure.

### BRIEF DESCRIPTION OF THE DRAWINGS

FIG. 1 is an AFM micrograph showing the dispersed phase of two conventional impact copolymers;

FIG. 2 is an AFM micrograph showing the dispersed phase of three impact copolymers according to embodiments of the invention;

FIG. 3 is an AFM micrograph showing the dispersed phase of three impact copolymers according to embodiments of the invention;

FIG. 4 is a photograph showing the transparent properties of comparative impact copolymers and impact copolymers according to embodiments of the invention;

FIG. 5A shows graphs of DMTA analysis for conventional impact copolymers of the comparative examples and FIG. 5B shows the same analysis using inventive examples;

FIG. 6 is a graph showing Flex modulus versus Notched Izod Impact results at Room Temperature (RTNI) values of iPP, comparative impact copolymers, and impact copolymers according to embodiments of the invention;

FIG. 7 is a graph showing Flex modulus as a function of rubber content of comparative impact copolymers, and impact copolymers according to embodiments of the invention;

FIG. 8 is a graph showing DMTA analysis as a function of rubber content of comparative impact copolymers, and impact copolymers according to embodiments of the invention;

FIG. 9A is a graph showing stress-strain curves of comparative impact copolymers and impact copolymers according to embodiments of the invention; and

FIG. 9B shows graphs of stress and strain at yield, and strain at break as a function of rubber content of comparative impact copolymers, and impact copolymers according to embodiments of the invention.

FIG. 9C is a graph showing strain at break for examples 1-6.

### DETAILED DESCRIPTION

Initially it is noted that, in the development of any actual embodiments, numerous implementation-specific decisions must be made to achieve the developer's specific goals, such as compliance with system-related and business-related constraints, which will vary from one implementation to another. Moreover, it will be appreciated that such a development effort might be complex and time consuming but would nevertheless be a routine undertaking for those of ordinary skill in the art having the benefit of this invention. In addition, the compositions and processes disclosed herein can also comprise components or steps other than those cited or specifically referred to.

Throughout the entire specification, including the claims, the following terms shall have the indicated meanings.

The term “and/or” refers to both the inclusive “and” case and the exclusive “or” case, whereas the term “and or” refers to the inclusive “and” case only, and such terms are used herein for brevity. For example, a composition comprising “A and/or B” may comprise A alone, B alone, or both A and B; and a composition comprising “A and or B” may comprise A alone, or both A and B.

The percentage of a particular monomer in a polymer is expressed herein as weight percent (wt %) based on the total weight of the polymer present. All other percentages are expressed as weight percent (wt %), based on the total weight of the particular composition present, unless otherwise noted. Room temperature is 25° C.±2° C. and atmospheric pressure is 101.325 kPa unless otherwise noted.

The term “consisting essentially of” in reference to a composition is understood to mean that the composition can include additional compounds other than those specified, in such amounts to the extent that they do not substantially interfere with the essential function of the composition, or if no essential function is indicated, in any amount up to 5 percent by weight of the composition.

For purposes herein a “polymer” refers to a compound having two or more “mer” units (see below for polyester mer units), that is, a degree of polymerization of two or more, where the mer units can be of the same or different species. A “homopolymer” is a polymer having mer units or residues that are the same species. A “copolymer” is a polymer having two or more different species of mer units or residues. A “terpolymer” is a polymer having three different species of mer units. “Different” in reference to mer unit species indicates that the mer units differ from each other by at least one atom or are different isomerically. Unless otherwise indicated, reference to a polymer herein includes a copolymer, a terpolymer, or any polymer comprising a plurality of the same or different species of repeating units.

The term “impact copolymer”, as used herein, refers to a thermoplastic resin comprising an elastomeric polymer, often referred to as a rubber, dispersed within a polyolefin continuous phase, e.g., polypropylene. Impact copolymers are suitable for transformation by various processing technologies including injection molding, blow molding, film, fiber, sheet extrusion, thermoforming, and the like.

As used herein, the prefixes di- and tri- generally refer to two and three, respectively. Similarly, the prefix “poly-” generally refers to two or more, and the prefix “multi-” to three or more.

The term “residue”, as used herein, means the organic structure of the monomer in its as-polymerized form as incorporated into a polymer, e.g., through polymerization of the corresponding monomer. Throughout the specification and claims, reference to the monomer(s) in the polymer is understood to mean the corresponding as—polymerized form or residue of the respective monomer.

For purposes herein, an essentially amorphous polymer is defined as a polymer that does not exhibit a substantially crystalline melting point, Tm, i.e., no discernable heat of fusion or a heat of fusion less than 5 J/g, when determined by differential scanning calorimetry (DSC) analysis from the second heating ramp by heating of the sample at 10° C./min from 0° C. to 300° C. For purposes herein, in the absence of DSC analysis, an amorphous polymer is indicated if injection molding of the polymer produces an article which is essentially clear, wherein the injection molding process used is known to produce articles having cloudy or opaque character upon injection molding of a semi-crystalline polymer having similar properties to the amorphous polymer.

Conversely, a polymer exhibiting a crystalline melting point may be crystalline or, as is more common for polyesters, semicrystalline. A semicrystalline polymer contains at least 5 weight percent of a region or fraction having a crystalline morphology and at least 5 weight percent of a region or fraction having an amorphous morphology.

For purposes herein, the melting temperature, crystallization temperature, glass transition temperature, etc., are determined by DSC analysis from the second heating ramp by heating of the sample at 10° C./min from 0° C. to 300° C. The melting, crystallization, and glass transition temperatures are measured as the midpoint of the respective endotherm or exotherm in the second heating ramp.

For purpose herein, proton NMR spectra are collected using a suitable instrument, e.g., 500 MHz Varian pulsed fourier transform NMR spectrometer equipped with a variable temperature proton detection probe operating at 120° C. Typical measurement of the NMR spectrum include dissolving of the polymer sample in 1,1,2,2-tetrachloroethane-d2 (“TCE-d2”) and transferring into a 5 mm glass NMR tube. Typical acquisition parameters were sweep width of 10 KHz, pulse width of 30 degrees, acquisition time of 2 seconds, acquisition delay of 5 seconds and number of scans was 120. Chemical shifts were determined relative to the TCE-d2 signal which was set to 5.98 ppm.

For purposes unless otherwise specified, the herein, average particle size of the dispersed phase within the continuous phase of the composition, also referred to herein as the domain size, is determined using atomic force microscopy (AFM) unless otherwise specified. Unless otherwise specified, the average particle size refers to volume-based particle size in which the measurement is based on the diameter of a sphere that has the same volume as a given particle according to the formula:

$$D = 2 \sqrt[3]{\frac{3 V}{4 π}}$$

of the representative sphere; and volume of the particle.

Atomic force microscopy is carried out using a Bruker ICON Atomic Force Microscope or the like. Typical analysis involves the cryo-microtoming of the sample prior to scanning in order to create a smooth surface at −80° C. After microtoming, the samples are purged under N2 in a desiccator before AFM evaluation. Imaging is typically conducted by tuning to the fundamental (1st) mode of the cantilever, setting the amplitude at 1.0 V and the drive frequency to about 5% below the free-air resonance frequency of the cantilever. Calibration is conducted using suitable standards, e.g., Asylum Research reference standard (10 microns×10 microns pitch grating×200 nm deep pits) for AFM SQC and X, Y, and Z calibration. Unless otherwise indicated, instrument calibration assumes an accuracy of +/−2%, with a true value for X—Y within 5% or better for Z. Representative scan sizes include 25×25 μm and 2.5×2.5 μm.

For purposes herein, the molecular weights are determined using high temperature gel permeation chromatography, “GPC-3D” employed on a suitable HPLC system, e.g., an Agilent PL-220® system) equipped with three in-line detectors: a differential refractive index detector (DRI), a light scattering (LS) detector, and a viscometer. Experimental details, including detector calibration, are described in Sun et al., in 34(19) Macromolecules, pp. 6812-6820, (2001) and references therein. A typical configuration includes three Agilent® PLgel 10 μm Mixed-B LS columns with a nominal flow rate of 0.5 mL/min and a nominal injection volume of 300 μL. The various transfer lines, columns, viscometer and differential refractometer (the DRI detector) are contained in an oven maintained at 145° C. Solvent is typically prepared by dissolving 6 grams of butylated hydroxytoluene as an antioxidant in 4 liters of reagent grade 1,2,4-trichlorobenzene (TCB). The TCB mixture was then filtered through a 0.1 μm Teflon® filter. The TCB was then degassed with an online degasser before entering the GPC-3D. Unless noted otherwise, polymer solutions are prepared by placing dry polymer in a glass container, adding the desired amount of TCB, then heating the mixture at 160° C. with continuous shaking for about 2 hours. All quantities are measured gravimetrically. Typical TCB densities used to express polymer concentration in mass/volume units are 1.463 g/ml at room temperature and 1.284 g/ml at 145° C. Suitable injection concentrations are from 0.5 to 2.0 mg/ml, with lower concentrations being used for higher molecular weight samples. To ensure accuracy, prior to running each sample, the DRI detector and the viscometer are typically purged. Flow rate in the apparatus is typically increased to 0.5 ml/minute, and the DRI allowed to stabilize for 8 hours before injecting the first sample. Likewise, the LS laser is typically stabilized at least 1 to 1.5 hours before running samples. The concentration, c, at each point in the chromatogram may then be calculated from the baseline-subtracted DRI signal, IDRI, using the following equation:

c=KDRIIDRI/(dn/dc),

where KDRI was a constant determined by calibrating the DRI, and (dn/dc) was the refractive index increment for the system. The refractive index, n=1.500 for TCB at 145° C. and λ=690 nm. Units on parameters throughout this description of the GPC-3D method were such that concentration is expressed in g/cm³, molecular weight is expressed in g/mole, and intrinsic viscosity is expressed in dL/g.

Suitable LS detectors include Wyatt Technology High Temperature Dawn Heleos™ II. The molecular weight, M, at each point in the chromatogram may be determined by analyzing the LS output using the Zimm model for static light scattering (M. B. Huglin, Light Scattering from Polymer Solutions, Academic Press, 1971):

$$\frac{{K}_{o} c}{Δ R ( θ )} = \frac{1}{MP ( θ )} + 2 {A}_{2} c ,$$

where ΔR(θ) was the measured excess Rayleigh scattering intensity at scattering angle θ, c was the polymer concentration determined from the DRI analysis, A₂ was the second virial coefficient. P(θ) was the form factor for a monodisperse random coil, and Kₒ was the optical constant for the system:

$${K}_{o} = \frac{4 {π}^{2} {{n}^{2} ( dn \text{/} dc )}^{2}}{{λ}^{4} {N}_{A}}$$

where NA was Avogadro's number, and (dn/dc) was the refractive index increment for the system, which take the same value as the one obtained from DRI method. The refractive index, n=1.500 for TCB at 145° C. and λ=657 nm.

All molecular weights are weight average (M_{w}) unless otherwise noted. All molecular weights are reported in g/mol unless otherwise noted. For most aliphatic polyolefin such as PE and PP, the Mark-Houwink parameters, dn/dc and A₂ can be found in the literature (Sun et al., in v.34(19) Macromolecules, pp. 6812-6820, (2001)). For a new polymer, the above parameters are determined separately.

If the polymer was completely soluble, the dn/dc value can be calculated from its mass recovery by comparing with a reference material (PE or PS) as shown in the below equation:

$$\frac{dn}{dc} = \frac{MR}{{MR}_{ref}} {( \frac{dn}{dc} )}_{ref} .$$

where “MR” was mass recovery. The Mark-Houwink parameter k and α can be obtained by fitting the linear part of [η] vs. MLS data. The A₂ was simply assumed to be the same as the reference material because it does not influence the MW calculation much at very dilute concentration.

Dynamic mechanical thermal analysis (“DMTA”) as used herein refers to analysis conducted according to procedures known in the art. Suitable instruments include those provide by Rheometrics, Inc (TA Instruments, USA) unless stated otherwise. For purposes herein, samples are prepared as small rectangular samples, the whole sample approximately 19.0 mm long by 5 mm wide by 0.5 mm thick polymer samples are molded at approximately 190° C. on either a Carver Lab Press or Wabash Press. If no stabilizer or antioxidant was already present in the polymer sample, about 0.1 wt % of butylated hydroxytoluene (“BHT”) was added to the sample. The polymer samples are then loaded into the open oven of the instrument between tool clamps on both ends. The length of sample is recorded once sample was stabilized at the testing temperature. After the oven and sample has reached testing temperature of 25° C., the test initiated. Calibration and quality control for the measurements are typically conducted by performing a dynamic temperature ramp at 6.28 rad/s (1 Hz) from −150° C. to 100° C. at 0.1% strain on a standard sample having known properties, e.g., ExxonMobil Exact™ 4049 plastomer, having a local maximum of the tan delta curve of −40.5° C., and a tan delta of 0.3478.

For purposes herein, ASTM refers to the American Society for Testing and Materials; it is to be understood that when an ASTM method is referred to for use in characterizing a property of a sample, the ASTM method referred to is the current revision of the ASTM method in force at the time of filing of this application, unless otherwise indicated.

As used herein, components which are melt miscible, also referred to as fully or completely melt miscible, form a homogenous solution under melt conditions, i.e., when heated above the highest melting point of the components present.

In one or more embodiments of the invention, an impact copolymer composition comprises a continuous phase comprising propylene and from 10 wt % to 80 wt % of a dispersed phase, based on the total amount of the composition, the dispersed phase comprising a copolymer of ethylene and a C₄-C₈ alpha-olefin having an average particle size of less than 500 nm. In one or more embodiments of the invention, the dispersed phase comprises an ethylene-butene copolymer comprising greater than or equal to about 10 wt % and less than or equal to about 40 wt % ethylene, based on the total weight of the copolymer. In one or more embodiments, the dispersed phase is essentially free of polypropylene. In other words, the dispersed phase comprises less than 5 wt %, preferably less than 1 wt %, preferably less than 0.1 wt % polypropylene or of propyl residues. In one or more embodiments of the invention, the ethylene-butene copolymer has a number averaged molecular weight from greater than or equal to about 100,000 g/mol to less than or equal to about 400,000 g/mol; and/or a melt index of less than 35 g/10 min @ 230° C. 2.16 kg, when determined according to ASTM D 1238.

In one or more embodiments of the invention, the dispersed phase has an average particle size, also referred to as the domain size, of less than or equal to about 100 nm, preferably less than or equal to about 50 nm, determined along the longest dimension of the particle.

In one or more embodiments of the invention, the dispersed phase consists essentially of amorphous butene-ethylene copolymer comprising greater than or equal to about 10 wt % and less than or equal to about 40 wt % ethylene, and the continuous phase consists essentially of isotactic polypropylene homopolymer.

In one or more embodiments of the invention, the impact copolymer composition comprises from about 10 wt % to about 50 wt % of the dispersed phase, preferably from about 10 wt % to about 30 wt %, based on the total weight of the composition.

In one or more embodiments of the invention, the continuous phase and the dispersed phase are fully melt miscible.

In one or more embodiments of the invention, the impact copolymer composition has a luminous transmittance of greater than or equal to about 60% when determined according to ASTM D1003 method B.

In one or more embodiments of the invention, the impact copolymer has an essentially single peak tan-delta loss modulus within a temperature range from −100° C. to 0° C., when determined according to ASTM D4440; and/or a flexural modulus of less than or equal to about 1,000 MPa, preferably less than or equal to about 500 MPa, preferably less than or equal to about 200 MPa, when determined according to ASTM D790; and/or an elongation at break of greater than or equal to about 400%, preferably greater than or equal to about 500%, when determined according to ASTM D638; and/or a modulus of elasticity (Young's Modulus) of less than or equal to about 30 MPa, when determined according to ASTM D638; and/or a tensile strength at yield of greater than or equal to about 10 MPa, preferably greater than or equal to about 20 MPa, preferably greater than or equal to about 25 MPa when determined according to ASTM D638; and/or a % strain at yield of greater than or equal to about 10%, preferably greater than or equal to about 20%, preferably greater than or equal to about 30%, when determined according to ASTM D638.

In one or more embodiments of the invention, an article comprises the impact copolymer composition according to any one, or any combination of embodiments disclosed herein.

In one or more embodiments, the continuous phase of the impact copolymer comprises propylene. In some embodiments, the continuous phase consists of, or consists essentially of polypropylene, preferably isotactic polypropylene. In alternative embodiments, the continuous phase comprises a propylene copolymer or terpolymer, further comprising from about 1 to about 45 wt % of a C₄-C₂₂ monomer. Non-limiting examples of α-olefins comonomers include, 1-butene, 1-pentene, 1-hexene, 1-heptene, 1-octene, 1-nonene, 1-decene, 1-undecene 1-dodecene, 1-tridecene, 1-tetradecene, 1-pentadecene, 1-hexadecene, 1-heptadecene, 1-octadecene, 1-nonadecene, 1-eicosene, 1-heneicosene, 1-docosene, 1-tricosene, 1-tetracosene, 1-pentacosene, 1-hexacosene, 1-heptacosene, 1-octacosene, 1-nonacosene, 1-triacontene, 4-methyl-1-pentene, 3-methyl-1-pentene, 5-methyl-1-nonene, 3,5,5-trimethyl-1-hexene, vinylcyclohexane, and vinylnorbornane. Non-limiting examples of cyclic olefins and diolefins include cyclopropene, cyclobutene, cyclopentene, cyclohexene, cycloheptene, cyclooctene, cyclononene, cyclodecene, norbornene, 4-methylnorbornene, 2-methylcyclopentene, 4-methylcyclopentene, vinylcyclohexane, norbornadiene, dicyclopentadiene, 5-ethylidene-2-norbornene, vinylcyclohexene, 5-vinyl-2-norbornene, 1,3-divinylcyclopentane, 1,2-divinylcyclohexane, 1,3-divinylcyclohexane, 1,4-divinylcyclohexane, 1,5-divinylcyclooctane, 1-allyl-4-vinylcyclohexane, 1,4-diallylcyclohexane, 1-allyl-5-vinylcyclooctane, and 1,5-diallylcyclooctane.

In embodiments the impact copolymer composition includes from about 5 wt % to about 80 wt % of a dispersed phase, preferably from about 10 wt % to about 50 wt %, more preferably from about 10 wt % to about 30 wt %, based on the total amount of the composition. In embodiments, the dispersed phase of the impact copolymer composition, also referred to herein as the rubber phase of the impact copolymer composition, comprises an ethylene-C₄-C₈ alpha-olefin copolymer. In embodiments, the rubber copolymer is an ethylene-butene copolymer, having an ethylene content from about 5 wt % up to about 45 wt %, preferably from about 10 wt % up to about 40 wt %, more preferably from about 15 wt % up to about 30 wt %. In embodiments, the dispersed phase comprises ethylene, butene, and one or more C₅ or higher monomer. In a preferred embodiment, the dispersed phase consists of or consists essentially of ethylene-butene copolymer comprising from about 10 wt % up to about 40 wt % ethylene. In embodiments, the dispersed rubber phase comprises less than about 15 wt %, preferably less than 1 wt %, preferably less than 0.1 wt % polypropylene, based on the total amount of the dispersed phase present.

In embodiments, the composition is the continuous phase, and/or the dispersed phase are selected such that the continuous phase and the dispersed phase are melt miscible, also referred to herein as being fully melt-miscible, at the proportions utilized in the resulting impact copolymer composition. Accordingly, in embodiments, a melt blend of the continuous phase with the dispersed phase is a homogeneous solution. Cooling of the melt produces the impact copolymer composition.

As is known in the art, the properties of an impact copolymer are influenced by the average particle size or domain size of the dispersed phase, along with the interaction of the dispersed phase with the continuous phase. Applicant has discovered that utilizing a rubber having high compatibility with polypropylene along with a very low modulus results in impact copolymers and other TPOs with improved properties. The well dispersed rubber domains have been found to provide improved toughening characteristics. In conventional impact copolymers, the average particle size of the dispersed phase is in the range of a few microns. In the impact copolymer disclosed herein, the rubber domain size has been drastically reduced to submicron levels of less than about 500 nm. In some embodiments, the rubber domain size is from about 100 nm to 500 nm. Still in other embodiments, the rubber domain size is less than or equal to about 100 nm, preferably less than or equal to about 75 nm, preferably less than or equal to about 50 nm, when determined using AFM.

The greatly reduced domain size of the dispersed phase results in a composition having an optical clarity not found in impact copolymers. In embodiments, the composition, has a luminous transmittance, which is defined as the ratio of transmitted light to the incident light, expressed as % of light transmitted, of greater than or equal to about 80%, preferably 90%, preferably 95% when determined according to ASTM D1003 method B.

It is believed these previously unknown small domains are due to the miscibility of iPP and the rubber in the melt. In contrast, ethylene-propylene copolymers, typical used as the rubber component in the art are highly immiscible with iPP.

In embodiments, the dispersed phase has a number averaged molecular weight of greater than or equal to about 80,000 g/mol, preferably greater than or equal to about 100,000 g/mol, with greater than or equal to about 150,000 g/mol being preferred. In embodiments the dispersed phase has a number averaged molecular weight of less than or equal to about 500,000 g/mol, preferably of less than or equal to about 400,000 g/mol, preferably of less than or equal to about 300,000 g/mol. In embodiments, the dispersed phase is an amorphous copolymer, preferably an amorphous ethylene-butene copolymer.

Dynamical-thermal mechanical analysis (DMTA) of conventional impact copolymers typically show a double peak in the tan delta analysis, wherein the peaks represent the two glass transitions (Tg) of the phase separated iPP and the dispersed rubber phase. In contrast, DMTA analysis of impact copolymers according to embodiments of the instant disclosure show a single, broad transition in the tan delta analysis from −100° C. to 0° C., when determined according to ASTM D4440 (i.e., over a temperature range from below the lowest glass transition temperature of the components of the composition, to a temperature above the highest glass transition temperature of the components of the composition), indicating a very strong interaction between the two phases.

In embodiments, the impact copolymer composition further comprises a flexural modulus of less than or equal to about 1,000 MPa, preferably less than or equal to about 500 MPa, preferably less than or equal to about 200 MPa, when determined according to ASTM D790. In embodiments, the impact copolymer composition further comprises an elongation at break of greater than or equal to about 200%, preferably 300%, preferably 400%, preferably greater than or equal to about 500%, when determined according to ASTM D638.

In embodiments, the impact copolymer composition further comprises a modulus of elasticity (also referred to in the art as a Young's Modulus) of less than or equal to about 50 MPa, preferably 40 MPa, preferably 30 MPa, when determined according to ASTM D638. In embodiments, the impact copolymer composition further comprises a tensile strength at yield of greater than or equal to about 10 MPa, preferably greater than or equal to about 20 MPa, preferably greater than or equal to about 25 MPa when determined according to ASTM D638. In embodiments, the impact copolymer composition further comprises a % strain at yield of greater than or equal to about 10%, preferably greater than or equal to about 15%, preferably greater than or equal to about 20%, when determined according to ASTM D638.

### Molded Products

The impact copolymer compositions described herein may also be used to prepare molded products in any molding process, including but not limited to, injection molding, gas-assisted injection molding, extrusion blow molding, injection blow molding, injection stretch blow molding, compression molding, rotational molding, foam molding, thermoforming, sheet extrusion, and profile extrusion. The molding processes are well known to those of ordinary skill in the art.

Further, the compositions described herein may be shaped into desirable end use articles by any suitable means known in the art. Suitable examples include thermoforming, vacuum forming, blow molding, rotational molding, slush molding, transfer molding, wet lay-up or contact molding, cast molding, cold forming matched-die molding, injection molding, spray techniques, profile co-extrusion, or combinations thereof.

Thermoforming is a process of forming at least one pliable plastic sheet into a desired shape. Typically, an extrudate film of the composition of this invention (and any other layers or materials) is placed on a shuttle rack to hold it during heating. The shuttle rack indexes into the oven which pre-heats the film before forming. Once the film is heated, the shuttle rack indexes back to the forming tool. The film is then vacuumed onto the forming tool to hold it in place and the forming tool is closed. The tool stays closed to cool the film and the tool is then opened. The shaped laminate is then removed from the tool. The thermoforming is accomplished by vacuum, positive air pressure, plug-assisted vacuum forming, or combinations and variations of these, once the sheet of material reaches thermoforming temperatures, typically of from 140° C. to 185° C. or higher. A pre-stretched bubble step is used, especially on large parts, to improve material distribution.

Blow molding is another suitable forming means for use with the compositions of this invention, which includes injection blow molding, multi-layer blow molding, extrusion blow molding, and stretch blow molding, and is especially suitable for substantially closed or hollow objects, such as, for example, gas tanks and other fluid containers. Blow molding is described in more detail in, for example, Concise Encyclopedia of Polymer Science and Engineering, pp. 90-92 (Jacqueline I. Kroschwitz, ed., John Wiley & Sons 1990).

Likewise, molded articles may be fabricated by injecting molten polymer into a mold that shapes and solidifies the molten polymer into desirable geometry and thickness of molded articles. Sheets may be made either by extruding a substantially flat profile from a die, onto a chill roll, or by calendaring.

### Non-Woven and Fiber Products

The impact copolymer compositions described herein may also be used to prepare nonwoven fabrics and fibers in any nonwoven fabric and fiber making process, including but not limited to, melt blowing, spunbonding, film aperturing, and staple fiber carding. Examples include continuous filament processes, spunbonding processes, and the like. The spunbonding process, as is well known in the art, involves the extrusion of fibers through a spinneret. These fibers are then drawn using high velocity air and laid on an endless belt. A calender roll is generally then used to heat the web and bond the fibers to one another although other techniques may be used such as sonic bonding and adhesive bonding.

The impact copolymer composition according to embodiments disclosed herein are useful in a wide variety of applications where a low flexural modulus is desired. Examples of those applications include automotive overshoot parts (e.g., door handles and skins such as dashboard, instrument panel and interior door skins), airbag covers, toothbrush handles, shoe soles, grips, skins, toys, appliance moldings and fascia, gaskets, furniture moldings and the like.

Other articles of commerce that can be produced from this invention include but are not limited by the following examples: awnings and canopies—coated fabric, tents/tarps coated fabric covers, curtains extruded soft sheet, protective cloth coated fabric, bumper fascia, instrument panel and trim skin, coated fabric for auto interior, geo textiles, appliance door gaskets, liners/gaskets/mats, hose and tubing, syringe plunger tips, light weight conveyor belt PVC replacement, modifier for rubber concentrates to reduce viscosity, single ply roofing compositions, recreation and sporting goods, grips for pens, razors, toothbrushes, handles, and the like. Other articles include marine belting, pillow tanks, ducting, dunnage bags, architectural trim and molding, collapsible storage containers, synthetic wine corks, IV and fluid administration bags, examination gloves, and the like.

Exemplary articles made using the polymeric compositions described herein include cookware, storage ware, toys, medical devices, sterilizable medical devices, sterilization containers, sheets, crates, containers, packaging, wire and cable jacketing, pipes, geomembranes, sporting equipment, chair mats, tubing, profiles, instrumentation sample holders and sample windows, outdoor furniture, e.g., garden furniture, playground equipment, automotive, boat and water craft components, and other such articles. In particular, the compositions are suitable for automotive components such as bumpers, grills, trim parts, dashboards and instrument panels, exterior door and hood components, spoiler, wind screen, hub caps, minor housing, body panel, protective side molding, and other interior and external components associated with automobiles, trucks, boats, and other vehicles. In particular, the polymeric compositions described herein are useful for producing “soft touch” grips in products such as personal care articles such as toothbrushes, etc.; toys; small appliances; packaging; kitchenware; sport and leisure products; consumer electronics; PVC and silicone rubber replacement medical tubing; industrial hoses; and shower tubing.

### Process

In embodiments of the invention, a process to produce an impact copolymer composition according to one or more embodiments or combinations of embodiments, comprises the steps of combining a first component comprising propylene with from 10 wt % to 80 wt % of a second component, based on the total weight of the first and second components, comprising a copolymer of ethylene and a C₄-C₈ alpha-olefin under melt conditions to form a homogenous melt mixture in which the first component and the second component are fully melt miscible; cooling the melt mixture to form the impact copolymer composition comprising the first component as a continuous phase and the second component as a dispersed phase having an average particle size of less than 500 nm.

In embodiments, the process further comprises selecting the continuous phase, and/or the dispersed phase such that the continuous phase and the dispersed phase are melt miscible at the proportions utilized in the resulting impact copolymer composition. Accordingly, in embodiments, the process includes selecting the continuous phase, e.g., a first component, and selecting the dispersed phase, e.g., a second component, such that a melt blend of the continuous phase with the dispersed phase (e.g., a melt blend of the first and second components) is a homogeneous solution. Followed by cooling of the melt to produce the impact copolymer composition.

### EMBODIMENTS

Accordingly, the instant disclosure relates to the following embodiments:
E1. An impact copolymer composition comprising a continuous phase comprising polypropylene and from 10 wt % to 80 wt % of a dispersed phase, based on the total amount of the composition, comprising a copolymer of ethylene and a C₄-C₈ alpha-olefin having an average particle size of less than 500 nm.
E2. The composition of embodiment E1, wherein the dispersed phase comprises an ethylene-butene copolymer comprising greater than or equal to about 10 wt % and less than or equal to about 40 wt % ethylene, based on the total weight of the dispersed phase.
E3. The composition of embodiment E1 or E2, wherein the ethylene-butene copolymer has a number averaged molecular weight from greater than or equal to about 100,000 g/mol to less than or equal to about 400,000 g/mol.
E4. The composition of any one of embodiments E1 through E3, wherein the ethylene-butene copolymer comprises a melt index of less than 35 g/10 min @ 230° C./2.16 kg, when determined according to ASTM D 1238.
E5. The composition of any one of embodiments E1 through E4, wherein the dispersed phase has an average particle size of less than or equal to about 250 nm.
E6. The composition of any one of embodiments E1 through E5, wherein the dispersed phase has an average particle size of less than or equal to about 100 nm.
E7. The composition of any one of embodiments E1 through E6, wherein the dispersed phase has an average particle size of less than or equal to about 50 nm.
E8. The composition of any one of embodiments E1 through E7, wherein the dispersed phase consists essentially of amorphous butene-ethylene copolymer comprising greater than or equal to about 10 wt % and less than or equal to about 40 wt % ethylene, and the continuous phase consists essentially of isotactic polypropylene homopolymer.
E9. The composition of any one of embodiments E1 through E8, comprising from about 10 wt % to about 50 wt % of the dispersed phase, based on the total weight of the composition.
E10. The composition of any one of embodiments E1 through E9, wherein the continuous phase and the dispersed phase are fully melt-miscible at a temperature above the melting points of both the continuous phase and the dispersed phase.
E11. The composition of any one of embodiments E1 through E10, having a luminous transmittance of greater than or equal to about 60% when determined according to ASTM D1003 method B.
E12. The composition of any one of embodiments E1 through E11 comprising an essentially single peak tan-delta loss modulus within a temperature range from −100° C. to 0° C., when determined according to ASTM D4440.
E13. The composition of any one of embodiments E1 through E12 comprising a flexural modulus of less than or equal to about 1,000 MPa, preferably less than or equal to about 500 MPa, preferably less than or equal to about 200 MPa, when determined according to ASTM D790.
E14. The composition of any one of embodiments E1 through E13 comprising an elongation at break of greater than or equal to about 400%, preferably greater than or equal to about 500%, when determined according to ASTM D638.
E15. The composition of any one of embodiments E1 through E14 comprising a modulus of elasticity (Young's Modulus) of less than or equal to about 30 MPa, when determined according to ASTM D638.
E16. The composition of any one of embodiments E1 through E15 comprising a tensile strength at yield of greater than or equal to about 10 MPa, when determined according to ASTM D638.
E17. The composition of any one of embodiments E1 through E16 comprising a % strain at yield of greater than or equal to about 10%, when determined according to ASTM D638.
E18. The composition of any one of embodiments E1 through E17 wherein the dispersed phase is essentially free of polypropylene, such that the dispersed phase comprises less than 5 wt %, preferably less than 1 wt %, preferably less than 0.1 wt % polypropylene or propyl residues, based on the total weight of the dispersed phase.
E19. An article comprising the impact copolymer composition according to any one of embodiments E1 through E18.
P1. A process to produce an impact copolymer composition comprising:
   combining a first component comprising propylene with from 10 wt % to 80 wt % of a second component, based on the total weight of the first and second components, comprising a copolymer of ethylene and a C₄-C₈ alpha-olefin under melt conditions to form a homogenous melt mixture in which the first component and the second component are fully melt miscible;
   cooling the melt mixture to form the impact copolymer composition comprising the first component as a continuous phase and the second component as a dispersed phase having an average particle size of less than 500 nm.
P2. The process according to embodiment P1, wherein the second component comprises an ethylene-butene copolymer comprising greater than or equal to about 10 wt % and less than or equal to about 40 wt % ethylene, based on the total weight of the second component.
P3. The process according to embodiment P1 or P2, wherein the second component is essentially free of polypropylene, such that the second component comprises less than 5 wt %, preferably less than 1 wt %, preferably less than 0.1 wt % polypropylene or propyl residues, based on the total weight of the second component.
P4. The process according to any one of embodiments P1 through P3, wherein the ethylene-butene copolymer is amorphous.
P5. The process according to any one of embodiments P1 through P4, wherein the ethylene-butene copolymer has a number averaged molecular weight from greater than or equal to about 100,000 g/mol to less than or equal to about 400,000 g/mol.
P6. The process according to any one of embodiments P1 through P5, wherein the ethylene-butene copolymer comprises a melt index of less than 35 g/10 min @ 230° C./2.16 kg, when determined according to ASTM D 1238.
P7. The process according to any one of embodiments P1 through P6, wherein the ethylene-butene copolymer comprises a viscosity of less than 2,500 Pa-s @ 100° C., preferably less than 1,000 Pa-s @ 100° C., preferably less than 500 Pa-s @ 100° C., when determined according to ASTM D1646.
P8. The process according to any one of embodiments P1 through P7, wherein the discontinuous phase has an average particle size of less than or equal to about 50 nm.
P9. The process according to any one of embodiments P1 through P8, wherein the first component consists essentially of isotactic polypropylene homopolymer, and the second component consists essentially of amorphous butene-ethylene copolymer comprising greater than or equal to about 10 wt % and less than or equal to about 40 wt % ethylene.
P10. The process according to any one of embodiments P1 through P9, wherein the impact copolymer composition comprises from about 10 wt % to about 50 wt % of the second component, based on the total weight of the composition.
P11. The process according to any one of embodiments P1 through P10, wherein the impact copolymer composition comprises a luminous transmittance of greater than or equal to about 60% when determined according to ASTM D1003 method B.
P12. The process according to any one of embodiments P1 through P11, wherein the impact copolymer composition comprises a single peak tan delta loss modulus within a temperature range from −100° C. to 0° C. when determined according to ASTM D4440.
P13. The process according to any one of embodiments P1 through P12, wherein the impact copolymer composition comprises a flexural modulus of less than or equal to about 1,000 MPa, preferably less than or equal to about 500 MPa, preferably less than or equal to about 200 MPa, when determined according to ASTM D790.
P14. The process according to any one of embodiments P1 through P13, wherein the impact copolymer composition comprises an elongation at break of greater than or equal to about 400%, preferably greater than or equal to about 500%, when determined according to ASTM D638.
P15. The process according to any one of embodiments P1 through P14, wherein the impact copolymer composition comprises a modulus of elasticity (Young's Modulus) of less than or equal to about 30 MPa, when determined according to ASTM D638.
P16. The process according to any one of embodiments P1 through P15, wherein the impact copolymer composition comprises a tensile strength at yield of greater than or equal to about 10 MPa, when determined according to ASTM D638.
P17. The process according to any one of embodiments P1 through P16, wherein the impact copolymer composition comprises a % strain at yield of greater than or equal to about 10%, when determined according to ASTM D638.
A1. An article produced by the process according to any one of embodiments P1 through P17.
A2. The article according to embodiment A1, comprising the composition according to any one of embodiments E1 thorough E19.

### EXAMPLES

The foregoing discussion can be further described with reference to the following non-limiting examples.

Blends were prepared comprising isotactic polypropylene (iPP) with butene-ethylene (BE) copolymer rubbers having an ethylene (C₂) contents ranging from 10 to 40 wt %. The bimodal blends had a rubber wt % between 10 to 75 and the BE copolymers had a Mn between 100,000 and 400,000 kDa. The iPP and the BE copolymer were blended using a Brabender internal mixer preheated at 210° C. The iPP and the BE copolymer are loaded simultaneously in the mixer while this is rotating at 60 rpm. After 5 minutes of mixing, the “add-pack” is added to the mixer and the blending continuous for another 5 minutes. After that, the polymer mixture is unloaded from the internal mixer and allowed to cool down. The “add-pack” consist of 1,000 ppm of sodium benzoate, 1,000 ppm of Irganox 1010, 1,000 ppm of bis(2,4,-ditherbutylphenyl)pentraerythriol diphosphate (U-626), 600 ppm of DHT, and 150 ppm of Irganox E201.

The BE copolymers utilized to produce these examples were prepared using catalyst OMC 1728, having the following structure.

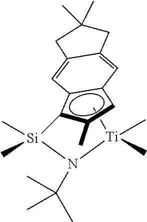

The activator used was dimethylaniliniumtetrakis(heptafluoronaphthyl)borate (also referred to as D9, MW=1145.3 g/mol). Catalyst solution was prepared daily and used on the same day. The solution was prepared by dissolving 80 mg of the catalyst and 140 mg of the activator in 450 ml toluene (catalyst concentration=1.884×10-07 mol/ml, catalyst/activator (molar ratio)=0.98). This solution was pumped into the reactor through a designated dip-tube at a desired rate using an Isco pump. OMC 1728 catalyst does not incorporate any stereo-regular butene (C₄) sequences, rendering the polymer completely amorphous. The moduli of the BE copolymers are dependent on the ethylene content. By lowering the ethylene content, the plateau modulus of the BE copolymer is reduced. Additionally, by using butene instead of propylene as the comonomer in the rubber, the modulus is further reduced. As the figures and data show, the inventive impact copolymers prepared with butene-rich BE copolymers as the rubber phase render much lower moduli values and possess other improvements over conventional impact copolymers.

The properties of the BE copolymers used are shown in Table 1.

TABLE 1

| | Mw | | Ethylene | Tg, | Viscosity | |
|---|---|---|---|---|---|---|
| Example | kg/mol | Mw/Mn | wt % | DSC | Pa-s | MI |
| BE1 | 238 | 2.08 | 19.62 | −44 | 2300 | 4 |
| BE2 | 158 | 2.09 | 15.65 | −42.5 | 360 | 30.8 |
| BE3 | 188 | 1.93 | 17.86 | −42 | 620 | 14.6 |

The following isotactic polypropylene obtained from Braskem (Houston, Tex.) was used in all examples.

| | ASTM | Typical |
|---|---|---|
| Braskem PP F350HC2 | Method | value |
| Nominal Melt Flow Rate | D-1238 | 35 g/10 min |
| (230° C./2.16 kg) | | |
| Tensile Strength at Yield | D-638 | 41 MPa |
| (2 in/min, 50 mm/min) | | |
| Elongation at Yield | D-638 | 5% |
| (2 in/min, 50 mm/min) | | |
| Flexural Modulus | D-790A | 2,068 MPa |
| (1.3 mm/min, 1% secant) | | |
| Notched Izod Impact | D-256A | 21 J/m |
| Strength at 23° C. | | |

The impact copolymer examples were prepared by combining the isotactic polypropylene with the BE rubber copolymer in a Brabender mixture and blending the melt at 210° C. until homogeneous. The material was then formed into a sheet for testing and allowed to cool.

The characteristics of the exemplary impact copolymers are shown in Table 2.

TABLE 2

| | | | | | Wt. % |
|---|---|---|---|---|---|
| | BE1 | BE2 | BE3 | F350HC2 | Rubber |
| Example | (g) | (g) | (g) | (g) | (% Cv) |
| 1 | 9 | | | 51 | 15 |
| 2 | 15 | | | 45 | 25 |
| 3 | 30 | | | 30 | 50 |
| 4 | | 15 | | 45 | 25 |
| 5 | | | 15 | 45 | 25 |
| 6 | | | 20 | 20 | 50 |
| 7 | | | 25 | 15 | 62.5 |
| 8 | | | 28.75 | 11.25 | 72 |

Two comparative examples of commercially available impact copolymers were also included: Comparative Example P7815E1 and Comparative Example PP8244E1 (ExxonMobil, Baytown, Tex.). The properties of these comparative examples are shown in Table 3.

TABLE 3

| | | PP7815 | PP8244E1 |
|---|---|---|---|
| | ASTM | PP-8wt % | PP-30 wt % |
| | Method | Rubber | Rubber |
| Nominal Melt Flow Rate | D-1238 | 35 g/10 min | 16 g/10 min |
| (230° C./2.16 kg) | | | |
| Tensile Strength at Yield | D-638 | 34.4 MPa | 19.2 MPa |
| (2 in/min, 50 mm/min) | | | |
| Elongation at Yield | D-638 | 3.9% | 7% |
| (2 in/min, 50 mm/min) | | | |
| Flexural Modulus | D-790A | 1830 MPa | 938 MPa |
| (1.3 mm/min, 1% secant) | | | |
| Flexural Modulus | D-790B | 2,070 MPa | 1080 MPa |
| (13 mm/min, 1% secant) | | | |
| Notched Izod Impact | D-256A | 67 J/m | No break |
| Strength at 23° C. | | | |

The rubber domains in the iPP matrix are remarkably small (<=50 nm), compared to conventional impact copolymers, for which domains are in the range of a few microns. Due to the low domain size these blends have high transparency. The Flex modulus values of these blends are approximately 50% lower than those for conventional impact copolymers at similar percent of the Be rubber (indicated as Cv, e.g., Cv=15 indicates 15 wt % Be copolymer), which makes these formulations good candidates for soft impact copolymer applications.

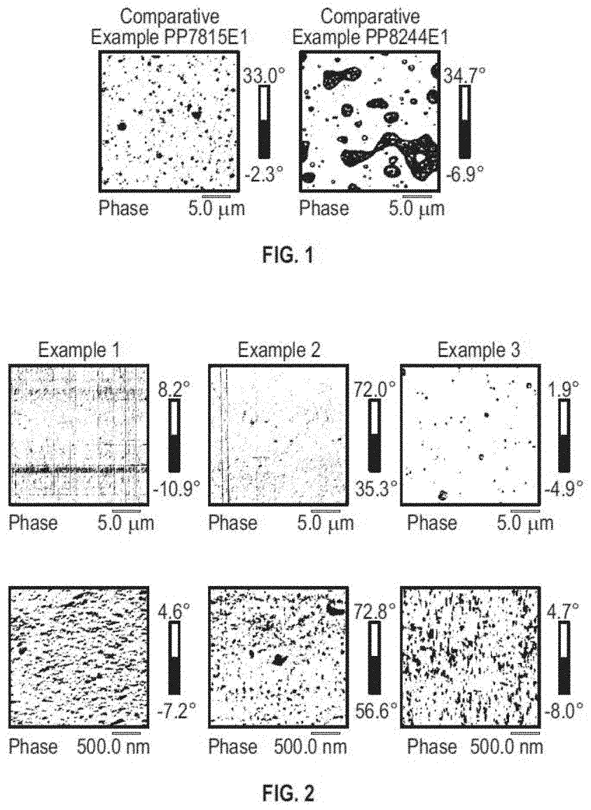

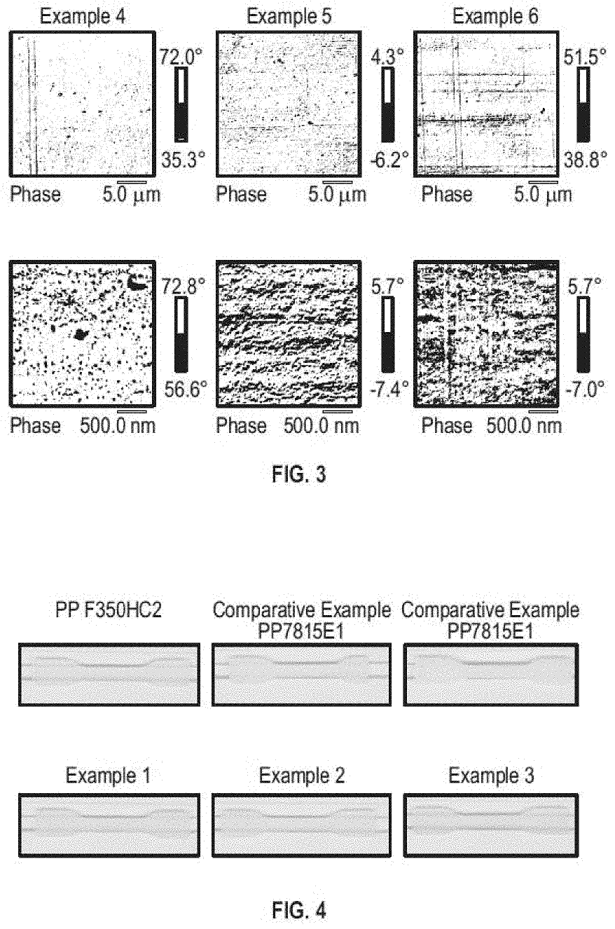

AFM micrographs of the two conventional impact copolymers i.e., Comparative Example P7815E1 and Comparative Example PP8244E1, are shown in FIG. 1. As these figures show, typical impact copolymers comprise phase-separated morphologies with domain sizes of the order of few microns. AFM micrographs of the inventive impact copolymers Examples 1, 2, and 3 are shown in FIG. 2, and Examples 4, 5, and 6 are shown in FIG. 3. As these figures show, the rubber domain sizes of the inventive impact copolymer are less than 50 nm.

FIG. 2 compares inventive impact copolymer examples 1, 2, and 3, each prepared with a different percentage of the same BE1 dispersed phase. The weight percentage of the BE1 copolymer is referred to in the figure as the Cv value, where Cv=15 represents 15 wt % BE1 copolymer dispersed in the isotactic polypropylene continuous phase. As the figure shows, example 1 with 15 wt % BE1 rubber has no structural features at the 5 micron resolution of the AFM micrograph. Rubber domains of <20 nm are revealed in the AFM micrograph of the same example 1 at the 500 nm resolution. A few submicron rubber domains can be seen in impact copolymers of examples 2 and 3, having 25 wt % and 50 wt % BE1 copolymer rubber, respectively. These larger domains are most likely due to processing conditions. However, the majority of the rubber domains in examples 2 and 3 have a size less than or equal to about 50 nm as shown in the AFM micrographs of examples 2 and 3 at the 500 nm resolution. To our knowledge, this is the first evidence of nanostructured impact copolymer compositions.

FIG. 3 compares the microstructure of examples 4, 5, and 6, each having the same 25% BE copolymer rubber wherein the rubber used to make the composition has a different melt index (MI). The three 5 micron AFM micrographs show similar, featureless characteristics. Consistent with the other examples, the AFT micrographs at 500 nm resolution show similar nanostructure consisting on droplets of sizes<50 nm.

Such small microstructure yields samples with high transparency, as is evident in the photographs shown in FIG. 4. The conventional impact copolymers are essentially opaque. In contrast, the inventive impact copolymers demonstrate excellent transparency, having a luminous transmittance of greater than or equal to about 60%. Accordingly, impact copolymers according to the instant disclosure are suitable for use when good optical properties are required.

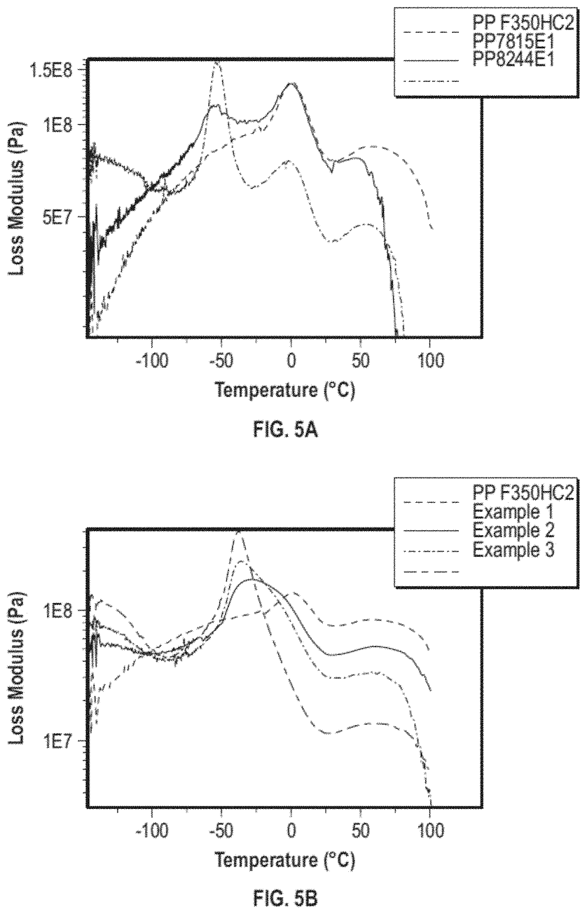

The high compatibility between iPP and the butene-ethylene rubber copolymers of the inventive impact copolymers is also demonstrated by dynamical-thermal mechanical analysis (DMTA) shown in FIGS. 5A and 5B. FIG. 5A shows the conventional impact copolymers of the comparative examples having the typical double peak in tan delta analysis, wherein each of the two peaks mark the two glass transitions (Tg) of the phase separated iPP and EP rubber domains. FIG. 5B shows the same analysis using the inventive examples. As FIG. 5B shows, the inventive impact copolymers demonstrate a single broad transition, which indicates very strong interaction between the two phases.

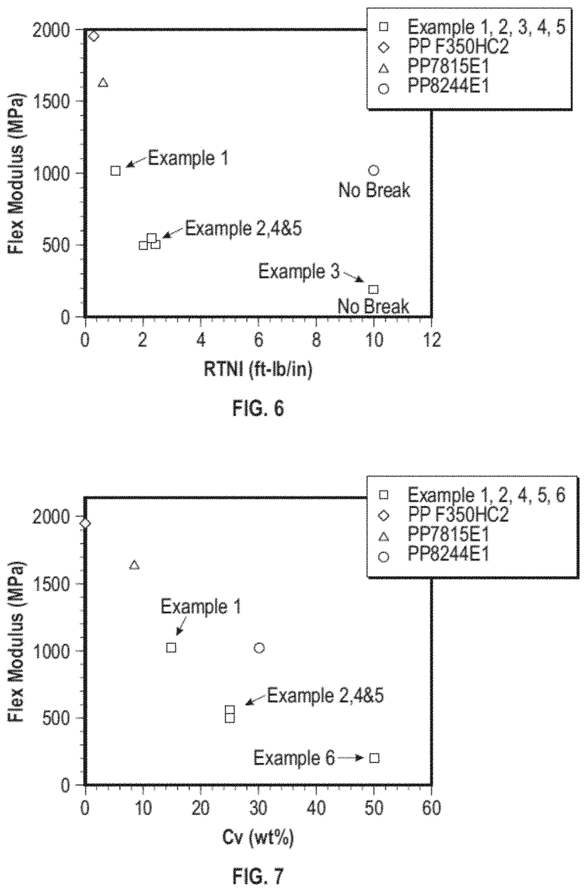

FIGS. 6 and 7 show the mechanical properties of the inventive impact copolymers. As shown in FIG. 6, the inventive examples exhibit an improved flexural modulus and Notched Izod Impact at room temperature (RTNI) compared to both the iPP and the comparative examples. As FIGS. 6 and 7 show, the experimental impact copolymers Cv=25 exhibit the flex modulus of around 500 MPa which is nearly 50% of the relative stiffness of PP8244E1, which is a 30 wt % rubber impact copolymer.

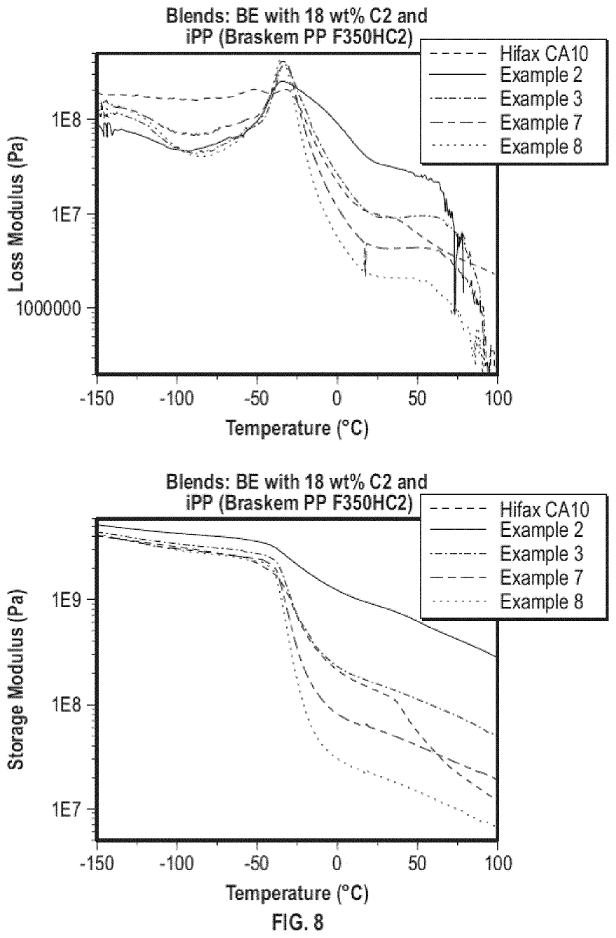

The very low modulus of the impact copolymers according to the instant disclosure is desirable for soft impact copolymer applications such as in roofing. FIG. 8 shows a comparison of DMTA measurements of a commercial comparative impact copolymer used in roofing applications (Hifax CA10A) with inventive impact copolymers having a weight percent Be copolymer rubber content from 25 to 72. As the figure shows, the inventive impact copolymers with 50 weight percent of the Be copolymer rubber match the thermal behavior and the moduli of Hifax CA10A up to 25° C., yet have improved, i.e., larger modulus, at higher temperatures. This is a desirable characteristic to avoid blocking during storage and handling.

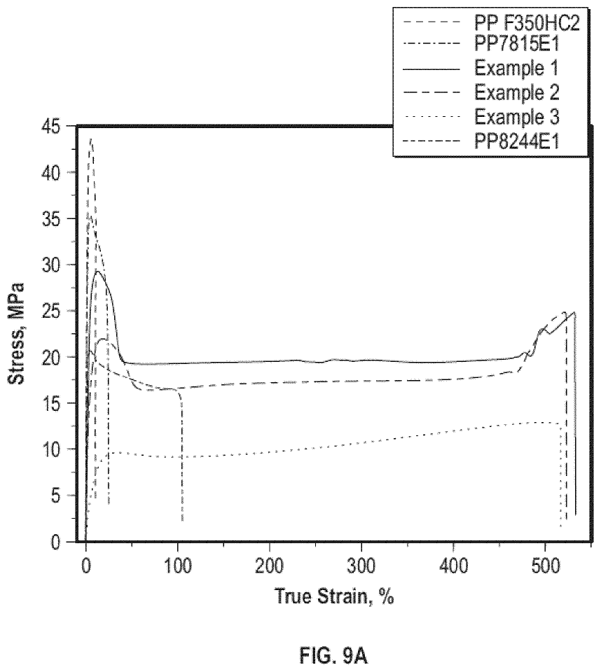

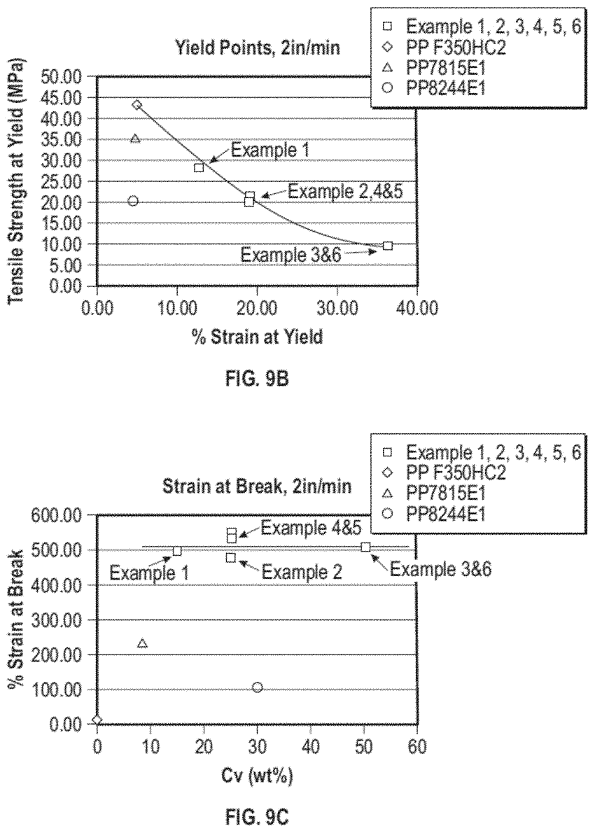

The tensile properties of the inventive impact copolymers compared to conventional impact copolymers and iPP are shown in FIGS. 9A and 9B. The inventive impact copolymers have remarkably large strain to break values compared to the comparative, conventional examples. The combination of low modulus with high elongation renders the impact copolymers of the instant disclosure ideal for roofing and other such applications.

We claim:

1. An impact copolymer composition comprising a continuous phase comprising polypropylene and from 10 wt % to 80 wt % of a dispersed phase, based on the total amount of the composition, comprising a copolymer of ethylene and a C₄-C₈ alpha-olefin, the dispersed phase having an average particle size of less than 500 nm.

2. The composition of claim 1, wherein the dispersed phase comprises an ethylene-butene copolymer comprising greater than or equal to about 10 wt % and less than or equal to about 40 wt % ethylene, based on the total weight of the dispersed phase.

3. The composition of claim 2, wherein the ethylene-butene copolymer has a number averaged molecular weight from greater than or equal to about 100,000 g/mol to less than or equal to about 400,000 g/mol.

4. The composition of claim 2, wherein the ethylene-butene copolymer comprises a melt index of less than 35 g/10 min @ 230° C./2.16 kg, when determined according to ASTM D 1238.

5. The composition of claim 1, wherein the dispersed phase has an average particle size of less than or equal to about 100 nm.

6. The composition of claim 1, wherein the dispersed phase has an average particle size of less than or equal to about 50 nm.

7. The composition of claim 1, wherein the dispersed phase consists essentially of amorphous butene-ethylene copolymer comprising greater than or equal to about 10 wt % and less than or equal to about 40 wt % ethylene, and the continuous phase consists essentially of isotactic polypropylene homopolymer.

8. The composition of claim 1, comprising from about 10 wt % to about 50 wt % of the dispersed phase, based on the total weight of the composition.

9. The composition of claim 1, wherein the continuous phase and the dispersed phase are fully melt-miscible at a temperature above the melting points of both the continuous phase and the dispersed phase.

10. The composition of claim 1, having a luminous transmittance of greater than or equal to about 60% when determined according to ASTM D1003 method B.

11. The composition of claim 1, comprising:
i) an essentially single peak tan-delta loss modulus within a temperature range from −100° C. to 0° C., when determined according to ASTM D4440;
ii) a flexural modulus of less than or equal to about 1,000 MPa, when determined according to ASTM D790;
iii) an elongation at break of greater than or equal to about 400%, when determined according to ASTM D638;
iv) a modulus of elasticity (Young's Modulus) of less than or equal to about 30 MPa, when determined according to ASTM D638;
v) a tensile strength at yield of greater than or equal to about 10 MPa, when determined according to ASTM D638;
vi) a % strain at yield of greater than or equal to about 10%, when determined according to ASTM D638;
or a combination thereof.

12. An article comprising the impact copolymer composition of claim 1.

13. The composition of claim 1, wherein the dispersed phase is essentially free of polypropylene.

14. A process to produce an impact copolymer composition comprising:
combining a first component comprising polypropylene with from 10 wt % to 80 wt % of a second component, based on the total weight of the first and second components, comprising a copolymer of ethylene and a C₄-C₈ alpha-olefin, under melt conditions to form a homogenous melt mixture in which the first component and the second component are fully melt miscible;
cooling the melt mixture to form the impact copolymer composition comprising the first component as a continuous phase and the second component as a dispersed phase having an average particle size of less than 500 nm.

15. The process of claim 14, wherein the second component comprises an ethylene-butene copolymer comprising greater than or equal to about 10 wt % and less than or equal to about 40 wt % ethylene, and is essentially free of polypropylene, based on the total weight of the second component.

16. The process of claim 15, wherein the ethylene-butene copolymer is amorphous.

17. The process of claim 14, wherein the ethylene-butene copolymer has a number averaged molecular weight from greater than or equal to about 100,000 g/mol to less than or equal to about 400,000 g/mol.

18. The process of claim 14, wherein the ethylene-butene copolymer comprises:
i) a melt index of less than 35 g/10 min @ 230° C./2.16 kg, when determined according to ASTM D 1238;
ii) a viscosity of less than 2,500 Pa-s @ 100° C., when determined according to ASTM D1646;
or a combination thereof.

19. The process of claim 14, wherein the discontinuous phase has an average particle size of less than or equal to about 50 nm.

20. The process of claim 14, wherein the first component consists essentially of isotactic polypropylene homopolymer, and the second component consists essentially of amorphous butene-ethylene copolymer comprising greater than or equal to about 10 wt % and less than or equal to about 40 wt % ethylene.

21. The process of claim 14, wherein the impact copolymer composition comprises from about 10 wt % to about 50 wt % of the second component, based on the total weight of the composition.

22. The process of claim 14, wherein the impact copolymer composition comprises:
i) a luminous transmittance of greater than or equal to about 60% when determined according to ASTM D1003 method B;
ii) a single peak tan delta loss modulus within a temperature range from −100° C. to 0° C. when determined according to ASTM D4440;
iii) a flexural modulus of less than or equal to about 1,000 MPa, when determined according to ASTM D790;
iv) an elongation at break of greater than or equal to about 400%, when determined according to ASTM D638;
v) a modulus of elasticity (Young's Modulus) of less than or equal to about 30 MPa, when determined according to ASTM D638;
vi) a tensile strength at yield of greater than or equal to about 10 MPa, when determined according to ASTM D638;
vii) a % strain at yield of greater than or equal to about 10%, when determined according to ASTM D638;
or a combination thereof.
